(19) United States
(12) Patent Application Publication
(10) Pub. No.: US 2026/0125873 A1
(43) Pub. Date: May 7, 2026

(54) EXCAVATOR

(71) Applicant: SUMITOMO CONSTRUCTION MACHINERY CO., LTD., Tokyo (JP)

(72) Inventor: Kazuma SHINKAI, Chiba (JP)

(21) Appl. No.: 19/235,053

(22) Filed: Jun. 11, 2025

Related U.S. Application Data
(63) Continuation of application No. PCT/JP2023/045249, filed on Dec. 18, 2023.

(30) Foreign Application Priority Data
Dec. 23, 2022 (JP) 2022-206318

(51) Int. Cl. E02F 3/96; B66C 13/16; E02F 9/26

(52) U.S. Cl. CPC E02F 3/963; B66C 13/16; E02F 9/264

(57) ABSTRACT

An excavator includes a lower travel body, an upper slewing body mounted on the lower travel body in a slewable manner, a sensor configured to detect an inclination of a machine body with respect to a horizontal plane, a display device installed inside a cabin provided in the upper slewing body, and a control device configured to cause the display device to display an icon image resembling a shape of the machine body as information regarding the inclination of the machine body when an operation mode is switched to a crane mode.

### CROSS-REFERENCE TO RELATED APPLICATIONS

This application is a continuation application of International Application No. PCT/JP2023/045249 filed on Dec. 18, 2023, and designated the U.S., which is based upon and claims priority to Japanese Patent Application No. 2022-206318 filed on Dec. 23, 2022, the entire contents of which are incorporated herein by reference.

### BACKGROUND

### 1. Technical Field

The present disclosure relates to an excavator.

### 2. Description of Related Art

An excavator is known in which a hook is attached to an attachment and an operation mode is switched to a crane mode based on information acquired by an object monitoring device.

### SUMMARY

An excavator according to an embodiment of the present disclosure includes a lower travel body, an upper slewing body mounted on the lower travel body in a slewable manner, a sensor configured to detect an inclination of a machine body with respect to a horizontal plane, a display device installed inside a cabin provided in the upper slewing body, and a control device configured to cause the display device to display an icon image resembling a shape of the machine body as information regarding the inclination of the machine body when an operation mode is switched to a crane mode.

### BRIEF DESCRIPTION OF THE DRAWINGS

FIG. 1 is a side view of an excavator 100 as an excavator according to an embodiment of the present disclosure;

FIG. 2 is a block diagram illustrating a configuration example of a drive system of the excavator;

FIG. 3 is a flowchart for explaining an operation of the excavator;

FIG. 4 is a first diagram illustrating a display example of a display device;

FIG. 5 is a second diagram illustrating a display example of the display device; and

FIGS. 6A, 6B, and 6C are diagrams for explaining icon images showing an inclination state of a machine body.

### DETAILED DESCRIPTION

In a conventional technique, it is difficult to have an operator ascertain an inclination of the machine body of the excavator when the operation mode is switched to the crane mode.

It is desirable to allow an operator to ascertain an inclination of a machine body.

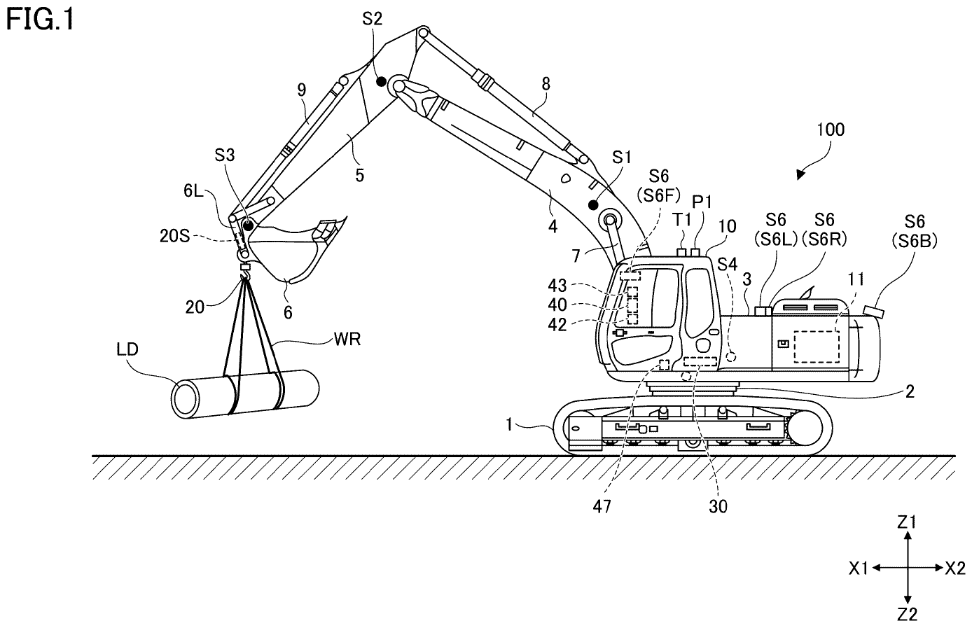

Hereinafter, embodiments will be described with reference the drawings. FIG. 1 is a side view of an excavator 100 as an excavator according to an embodiment of the present disclosure. In the accompanying drawings, an X axis, a Y axis, and a Z axis are orthogonal to each other. Specifically, the X axis extends along the longitudinal axis of the excavator 100, the Y axis extends along the lateral axis of the excavator 100, and the Z axis extends along the slew axis of the excavator 100. In the present embodiment, the X axis and the Y axis extend in the horizontal direction, and the Z axis extends in the vertical direction.

In the excavator 100, an upper slewing body 3 is slewably mounted on a lower travel body 1 via a slew mechanism 2. A boom 4 is attached to the upper slewing body 3. An arm 5 is attached to the distal end of the boom 4, and a bucket 6 as an end attachment is attached to the distal end of the arm 5.

The boom 4, the arm 5, and the bucket 6 constitute an excavation attachment as an example of an attachment, and are hydraulically driven by a boom cylinder 7, an arm cylinder 8, and a bucket cylinder 9, respectively. A boom angle sensor S1 is attached to the boom 4, an arm angle sensor S2 is attached to the arm 5, and a bucket angle sensor S3 is attached to the bucket 6.

The boom angle sensor S1 is an example of a posture detection device, and detects a rotation angle of the boom 4. In the present embodiment, the boom angle sensor S1 is an accelerometer, and is capable of detecting a rotation angle of the boom 4 with respect to the upper slewing body 3 (hereinafter, referred to as a “boom angle”). The boom angle becomes minimum when the boom 4 is lowered to a lowest position, and increases as the boom 4 is raised, for example.

The arm angle sensor S2 is an example of a posture detection device, and detects a rotation angle of the arm 5. In the present embodiment, the arm angle sensor S2 is an accelerometer, and is capable of detecting a rotation angle of the arm 5 with respect to the boom 4 (hereinafter, referred to as a “arm angle”). The arm angle becomes minimum when the arm 5 is closed to the maximum, and increases as the arm 5 is opened, for example.

The bucket angle sensor S3 is an example of a posture detection device, and detects a rotation angle of the bucket 6. In the present embodiment, the bucket angle sensor S3 is an accelerometer, and is capable of detecting a rotation angle of the bucket 6 with respect to the arm 5 (hereinafter, referred to as a “bucket angle”). The bucket angle becomes minimum when the bucket 6 is closed to the maximum, and increases as the bucket 6 is opened, for example.

The boom angle sensor S1, the arm angle sensor S2, and the bucket angle sensor S3 may be an inertial measurement unit (IMU). The boom angle sensor S1, the arm angle sensor S2, and the bucket angle sensor S3 may be potentiometers using variable resistors, stroke sensors that detect stroke amounts of corresponding hydraulic cylinders, rotary encoders that detect rotation angles around coupling pins, gyro sensors, combinations of accelerometers and gyro sensors, or the like.

In the present embodiment, the bucket 6 is coupled to the distal end of the bucket cylinder 9 via a bucket link 6L. The bucket link 6L is provided with a storage part 20S for storing a hook 20 used in crane work. The hook 20 is stored in the storage part 20S when excavation work is performed, and is pulled out from the storage part 20S as illustrated in FIG. 1 when crane work is performed.

The upper slewing body 3 is provided with a cab 10 as an operator's cab and a power source such as an engine 11. The upper slewing body 3 is provided with a controller 30, a display device 40, an input device 42, a sound output device 43, a storage device 47, a position measuring device P1, a machine body inclination sensor S4, an object monitoring device S6, and a communication device T1.

The controller 30 functions as a main control unit that performs drive control of the excavator 100. In the present embodiment, the controller 30 is configured by a computer including a CPU, a RAM, a ROM, and the like. The various functions of the controller 30 are realized by the CPU executing programs stored in the ROM, for example. The various functions include, for example, a machine guidance function of guiding a manual operation of the excavator 100 by an operator and a machine control function of automatically assisting a manual operation of the excavator 100 by an operator. A machine guidance apparatus 50 included in the controller 30 performs the machine guidance function and the machine control function.

The display device 40 displays various information. The display device 40 may be connected to the controller 30 via a communication network such as a CAN, or may be connected to the controller 30 via a dedicated line.

The input device 42 is configured to allow an operator to input various kinds of information to the controller 30. The input device 42 includes a touch panel, a knob switch, a membrane switch, and the like installed in the cab 10.

The input device 42 of the present embodiment may be provided in the display device 40. The input device 42 may include, for example, a switch, etc. for operating an air conditioner provided in the cab 10.

The sound output device 43 is a device that outputs sound. The sound output device 43 may be, for example, an in-vehicle speaker connected to the controller 30, or an alarm such as a buzzer. In the present embodiment, the sound output device 43 outputs various kinds of information by sound in response to a sound output command from the controller 30.

The storage device 47 is a device for storing various kinds of information. The storage device 47 is, for example, a nonvolatile storage medium such as a semiconductor memory. The storage device 47 may store information that is output from various devices during an operation of the excavator 100, or may store information acquired via various devices before an operation of the excavator 100 is started. The storage device 47 may store, for example, information regarding a target working surface acquired via the communication device T1 or the like. A target construction surface may be set by an operator of the excavator 100 or may be set by a construction manager or the like.

The position measurement device P1 measures a position and an orientation of the upper slewing body 3. The position measurement device P1 is, for example, a GNSS compass, and detects a position and an orientation of the upper slewing body 3 and outputs the detected values to the controller 30. For this reason, the position measurement device P1 can function as an orientation detection device that detects an orientation of the upper slewing body 3. The orientation detection device may be an azimuth sensor attached to the upper slewing body 3.

The machine body inclination sensor S4 detects an inclination of the upper slewing body 3 with respect to the horizontal plane. In the present embodiment, the machine body inclination sensor S4 is an accelerometer that detects an inclination angle around the longitudinal axis (roll angle) and an inclination angle around the lateral axis (pitch angle) of the upper slewing body 3. The longitudinal axis and the lateral axis of the upper slewing body 3 are orthogonal to each other at, for example, an excavator center point which is one point on the slew axis of the excavator 100. The machine body inclination sensor S4 of the present embodiment may be an inertial measurement unit (IMU). The machine body inclination sensor S4 of the present embodiment is an example of a digital level.

The object monitoring device S6 acquires information on the periphery of the excavator 100. In the present embodiment, the object monitoring device S6 includes a front camera S6F that images space in front of the excavator 100, a left camera S6L that images space on the left side of the excavator 100, a right camera S6R that images space on the right side of the excavator 100, and a rear camera S6B that images space in the rear of the excavator 100.

The object monitoring device S6 is an imaging device, for example a monocular camera of imaging devices having an imaging device, such as a charge coupled device (CCD) or a complementary metal oxide semiconductor (CMOS), and outputs a captured image to the display device 40. The imaging device may be a stereo camera, a range image camera, or the like. The object monitoring device S6 may be a combination of two different types of imaging devices. For example, a stereo camera, a distance image camera, or the like may be arranged separately from the monocular camera. The object monitoring device S6 may be a millimeter wave radar, a laser range sensor, a lidar, or the like, or may be a combination of an imaging device and a millimeter wave radar, a laser range sensor, a lidar, or the like.

The front camera S6F is attached to, for example, the ceiling of the cab 10, that is, inside the cab 10. The air conditioner may be installed on the roof of the cab 10, namely on the outside of the cab 10. The left camera S6L is attached to the left end of the upper surface of the upper slewing body 3; the right camera S6R is attached to the right end of the upper surface of the upper slewing body 3; and the rear camera S6B is attached to the rear end of the upper surface of the upper slewing body 3.

The communication device T1 controls communication with an external device outside the excavator 100. In the present embodiment, the communication device T1 controls communication with external devices via a satellite network, a mobile telephone network, the Internet, or the like.

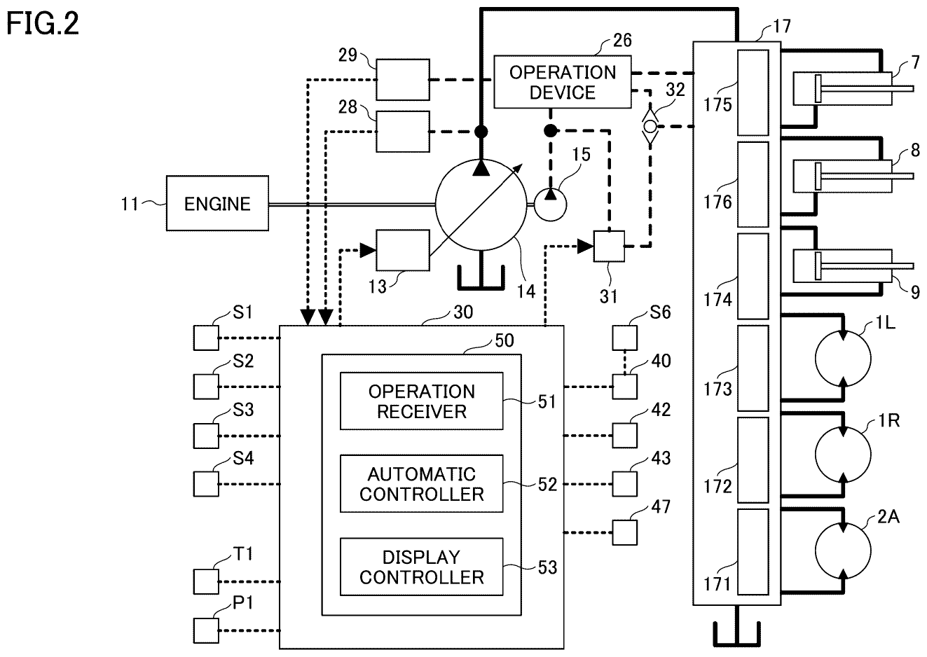

FIG. 2 is a block diagram illustrating an example of the configuration of the drive system of the excavator, and a mechanical power system, a hydraulic oil line, a pilot line, and an electric control system are illustrated by a double line, a solid line, a broken line, and a dotted line, respectively.

The drive system of the excavator mainly includes the engine 11, a regulator 13, a main pump 14, a pilot pump 15, a control valve 17, an operation device 26, a discharge pressure sensor 28, an operation pressure sensor 29, the controller 30, a proportional valve 31, and the like.

The engine 11 is a drive source of the excavator. In the present embodiment, the engine 11 is, for example, a diesel engine that operates to maintain a predetermined rotation speed. An output shaft of the engine 11 is connected to respective input shafts of the main pump 14 and the pilot pump 15.

The main pump 14 supplies a hydraulic oil to the control valve 17 via the hydraulic oil line. In the present embodiment, the main pump 14 is a swash plate type variable displacement hydraulic pump.

The regulator 13 controls a discharge amount of the main pump 14. In the present embodiment, the regulator 13 controls a discharge amount of the main pump 14 by adjusting the swash plate tilting angle of the main pump 14 in response to a control command from the controller 30. For example, the controller 30 receives an output from the operation pressure sensor 29 and outputs a control command to the regulator 13 as necessary, and changes the discharge amount of the main pump 14.

The pilot pump 15 supplies a hydraulic oil to various hydraulic control devices including the operation device 26 and the proportional valve 31 via the pilot line. In the present embodiment, the pilot pump 15 is a fixed displacement hydraulic pump.

The control valve 17 is a hydraulic control device that controls a hydraulic system in the excavator. The control valve 17 includes control valves 171 through 176. The control valve 17 can selectively supply a hydraulic oil discharged by the main pump 14 to one or a plurality of hydraulic actuators through the control valves 171 to 176. The control valves 171 to 176 control a flow rate of a hydraulic oil flowing from the main pump 14 to the hydraulic actuator and a flow rate of the hydraulic oil flowing from the hydraulic actuator to a hydraulic oil tank. The hydraulic actuators include the boom cylinder 7, the arm cylinder 8, the bucket cylinder 9, a left travel hydraulic motor 1L, a right travel hydraulic motor 1R, and a slew hydraulic motor 2A. The slew hydraulic motor 2A may be a slew motor-generator as an electric motor.

The operation device 26 is a device used by an operator to operate the actuators. Examples of the actuators are at least a hydraulic actuator or an electric actuator, or both of them. In the present embodiment, the operation device 26 supplies a hydraulic oil discharged by the pilot pump 15 to the pilot port of a corresponding control valve in the control valve 17 via the pilot line. The pressure (pilot pressure) of a hydraulic oil supplied to each of the pilot ports is, in principle, a pressure corresponding to an operation direction and an operation amount of the operation device 26 corresponding to each of the hydraulic actuators. At least one of the operation devices 26 is configured to be able to supply a hydraulic oil discharged by the pilot pump 15 to the pilot port of a corresponding control valve in the control valve 17 via the pilot line and a shuttle valve 32.

The discharge pressure sensor 28 detects a discharge pressure of the main pump 14. In the present embodiment, the discharge pressure sensor 28 outputs the detected value to the controller 30.

The operation pressure sensor 29 detects content of an operator's operation using the operation device 26. In the present embodiment, the operation pressure sensor 29 detects an operation direction and an operation amount of the operation device 26 corresponding to each of the actuators in the form of pressure, and outputs the detected value to the controller 30. Content of an operation of the operation device 26 may be detected using a sensor other than the operation pressure sensor.

The proportional valve 31 is arranged in a pipe line connecting the pilot pump 15 and the shuttle valve 32, and is configured to be able to change the flow passage area of the pipe line. In the present embodiment, the proportional valve 31 operates in response to a control command that is output from the controller 30. For this reason, the controller 30 can supply a hydraulic oil discharged by the pilot pump 15 to the pilot port of a corresponding control valve in the control valve 17 via the proportional valve 31 and the shuttle valve 32, regardless of the operation of the operation device 26 by an operator.

The shuttle valve 32 has two inlet ports and one outlet port. One of the two inlet ports is connected to the operation device 26, and the other is connected to the proportional valve 31. The outlet port is connected to a pilot port of a corresponding control valve in the control valve 17. For this reason, the shuttle valve 32 can cause the higher one of the pilot pressure generated by the operation device 26 and the pilot pressure generated by the proportional valve 31 to act on the pilot port of the corresponding control valve.

With this configuration, even when an operation is not performed on a specific operation device 26, the controller 30 can operate the hydraulic actuator corresponding to the specific operation device 26.

Next, the machine guidance apparatus 50 included in the controller 30 is described. The machine guidance apparatus 50 is configured to perform machine guidance function, for example. In the present embodiment, the machine guidance apparatus 50 is configured to notify an operator of operation information, for example, a distance between a target construction surface and a work site of the attachment, a distance between the center of gravity of a suspended load LD (see FIG. 1) and a hanging position of the hook 20, and the like. The data related to the target construction surface is stored in advance in the storage device 47, for example. The data related to the target construction surface is expressed by, for example, a reference coordinate system. The reference coordinate system is, for example, a world geodetic system.

The world geodetic system is a three dimensional orthogonal XYZ coordinate system with the origin at the center of gravity of the earth, the X axis in the direction of the intersection of the Greenwich meridian and the equator, the Y axis in the direction of 90 degrees east longitude, and the Z axis in the direction of the north pole. An operator may determine a discretionarily chosen point of the construction site as a reference point and set the target construction surface based on a relative positional relationship with respect to the reference point. The work site of the attachment is, for example, the claw tip of the bucket 6, the back surface of the bucket 6, or the like. The suspended load LD is, for example, an object that interferes with excavation work, an object to be buried, or an object that has been buried, and specifically, is a soil pipe, wood, a surplus soil bag, a tetrapod, or the like. The machine guidance apparatus 50 guides operation of the excavator 100 by notifying an operator of work information via the display device 40, the sound output device 43, and the like.

The machine guidance apparatus 50 may execute the machine control function that automatically assists manual operation of the excavator by an operator. For example, the machine guidance apparatus 50 may automatically operate at least one of the boom 4, the arm 5, and the bucket 6 in such a manner that the target construction surface and the tip position of the bucket 6 coincide with each other, while an operator is manually performing excavation operation.

In the present embodiment, the machine guidance apparatus 50 is incorporated in the controller 30, but may be a control device provided separately from the controller 30. In this case, the machine guidance apparatus 50 is configured by a computer including a CPU and an internal memory, for example, similarly to the controller 30. Various functions of the machine guidance apparatus 50 are realized by the CPU executing the program stored in the internal memory. The machine guidance apparatus 50 and the controller 30 are connected to each other via a communication network such as a CAN so as to be able to communicate with each other.

Specifically, the machine guidance apparatus 50 acquires information from the boom angle sensor S1, the arm angle sensor S2, the bucket angle sensor S3, the machine body inclination sensor S4, the object monitoring device S6, the position measuring device P1, the communication device T1, the input device 42, and the like. Then, the machine guidance apparatus 50 calculates a vertical distance between the bucket 6 and the target construction surface based on the acquired information, for example, and notifies an operator of the excavator of the calculated vertical distance between the bucket 6 and the target construction surface by sound and image display.

The machine guidance apparatus 50 may calculate a horizontal distance between a hanging position of the hook 20 and a center of gravity position of the suspended load LD, and notify an operator of the excavator of the calculated horizontal distance between a hanging position and a center of gravity position by sound and image display, for example. The hanging position is, for example, a position where a wire WR is hung. The machine guidance apparatus 50 may notify an operator of the excavator of a vertical distance between a target hanging position of the hook 20 and a target hanging position, for example. The target hanging position is a position set directly above a center of gravity of the suspended load LD, and the height thereof is determined based on the length of the wire WR. In this case, the length of the wire WR may be input in advance via the input device 42.

The machine guidance apparatus 50 of the present embodiment causes the display device 40 to display information regarding an inclination of the machine body of the excavator 100 based on the value that is output from the machine body inclination sensor S4 when the crane mode is selected as an operation mode of the excavator 100. In other words, information regarding an inclination of the machine body in the present embodiment is information that is output from the digital level, namely information regarding the digital level. In the present embodiment, by this control, an operator can ascertain an inclination of the machine body of the excavator 100 when the operation mode of the excavator 100 is switched to the crane mode.

The machine guidance apparatus 50 of the present embodiment turns the information regarding an inclination of the machine body displayed on the display device 40 to non-display when the operation mode of the excavator 100 is switched from the crane mode to an operation mode other than the crane mode. The operation mode other than the crane mode may be, for example, an excavator mode, which is described later.

In the present embodiment, by this control, it is possible to prevent information unrelated to the operation mode of the excavator 100 from being displayed on the display device 40.

In order to realize the above-described functions, the machine guidance apparatus 50 includes, for example, an operation receiver 51, an automatic controller 52, and a display controller 53.

The operation receiver 51 receives an input of an operation on the excavator 100 via the operation device 26, the input device 42, or the like.

The automatic controller 52 automatically assists manual operation of the excavator by an operator by automatically operating the actuator. For example, in the case where an operator manually performs an arm closing operation, the automatic controller 52 may automatically extend and contract at least one of the boom cylinder 7, the arm cylinder 8, and the bucket cylinder 9 in such a manner that the target construction surface and the position of the claw tip of the bucket 6 coincide with each other. In this case, an operator can close the arm 5 while making the claw tip of the bucket 6 coincide with the target construction surface, for example, only by operating an arm operation lever in the closing direction. This automatic control may be configured to be executed when a predetermined switch, which is one of the input devices 42, is pressed. The predetermined switch is, for example, a machine control switch (hereinafter, referred to as an “MC switch”), and may be arranged at the distal end of the arm operation lever as a knob switch.

In the present embodiment, the automatic controller 52 automatically operates each actuator by individually and automatically adjusting the pilot pressure acting on the control valve corresponding to each actuator.

When the crane mode is selected as an operation mode, the automatic controller 52 may automatically operate at least one of the actuators to move the hanging position of the hook 20 to a position directly above the center of gravity of the suspended load LD. For example, the upper slewing body 3 may be slewed by automatically rotating the slew hydraulic motor 2A, or the attachment may be extended and retracted by automatically extending and retracting the boom cylinder 7 and the arm cylinder 8.

The operation mode includes, for example, the crane mode and the excavator mode. An operator of the excavator 100 can switch the operation mode by operating a predetermined switch arranged in the cab 10. The predetermined switch is, for example, a mode switch as a push button switch arranged near the display device 40. The predetermined switch may be a mode switch as a software button displayed on the display device 40 including a touch panel.

In the present embodiment, the operation mode may be switched to the crane mode based on the information acquired by the object monitoring device S6. Furthermore, in the present embodiment, the operation mode may be switched to the crane mode when it is determined that the attachment is in a predetermined posture based on an output of the posture detection device.

In the crane mode, the operation speed of the actuator is limited as compared to the excavator mode. For example, the slew speed of the upper slewing body 3 when a slew operation lever 26C is operated in the crane mode is limited to be lower than the slew speed of the upper slewing body 3 when the slew operation lever 26C is operated by the same operation amount in the excavator mode.

The same applies to the operating speed of the left travel hydraulic motor 1L, the right travel hydraulic motor 1R, the boom 4, the arm 5, and the bucket 6. The speed limitation is realized by, for example, reducing a spool stroke amount of the control valve with respect to the operation amount of the operation device 26, reducing a discharge amount of the main pump 14, reducing the engine speed, or the like. However, in the present embodiment, the power is not limited in the crane mode. In other words, a maximum load that can be lifted is not limited.

The display controller 53 controls display on the display device 40. Specifically, when the operation mode of the excavator 100 is switched from the excavator mode to the crane mode, the display controller 53 switches the display of the display device 40 to a display for the crane mode. Specifically, when the operation mode of the excavator 100 is switched from the excavator mode to the crane mode, the display controller 53 causes the display device 40 to display information indicating that the operation mode has been switched and information regarding an inclination of the machine body of the excavator 100.

When the operation mode of the excavator 100 is switched from the excavator mode to the crane mode, the display controller 53 switches information to be displayed in a specific display area of the display device 40 from information displayed in the excavator mode to information regarding an inclination of the machine body.

In the present embodiment, by controlling the display in this way, a unique display area for displaying information regarding an inclination of the machine body is not required in the display area of the display device 40, and the display area can be therefore effectively used.

Even when the excavator 100 is operating in the crane mode, upon receipt of an operation of changing content of information displayed in a specific display area in the excavator mode, the display controller 53 may switch the display in a specific display area from information regarding an inclination of the machine body to information displayed in the excavator mode.

In the present embodiment, by controlling the display in this way, an operator can perform the same operation in the crane mode as in the excavator mode.

When the display controller 53 receives an operation of moving the machine body of the excavator 100 after receiving an operation of changing content of information displayed in a specific display area, the display controller 53 once again displays information regarding an inclination of the machine body in the specific display area. The operation of moving the machine body of the excavator 100 may be, in other words, a lever operation.

In the present embodiment, by controlling the display in this way, when an operator returns to a slope work in the crane mode, information regarding an inclination of the machine body can be automatically displayed, and the operation for displaying information regarding inclination of the machine body is not required.

In the case where a certain length of time has elapsed without the operation of moving the machine body being performed after an operation of changing the content of the information displayed in a specific display area is received, the display controller 53 causes information regarding an inclination of the machine body to be displayed again in the specific display area.

In the present embodiment, by controlling the display in this way, when the operation mode of the excavator 100 is the crane mode, information regarding an inclination of the machine body can be always displayed on the display device 40.

A specific display area in the present embodiment may be an area in which information that does not change in response to an operation of the machine body of the excavator 100 is displayed. In other words, a specific display area is an area in which information that does not change due to an operation of the machine body of the excavator 100 is displayed. Specifically, for example, a specific display area may be a display area in which an operation state of an air conditioner included in the excavator 100 is displayed.

In the present embodiment, by determining a specific display area in this way, it is possible to suppress the influence of turning the display of information to non-display.

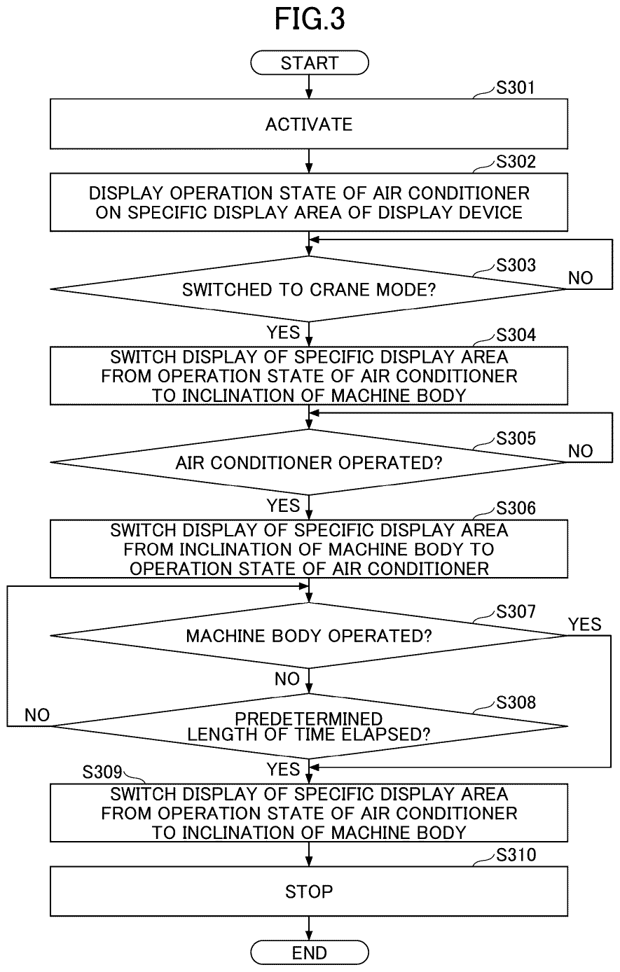

Hereinafter, the operation of the excavator 100 of the present embodiment will be described with reference to FIG. 3. FIG. 3 is a flowchart for explaining an operation of the excavator 100.

In the following example of FIG. 3, a display area displaying an operation state of the air conditioner included in the excavator 100 is designated as a specific area. In the display area for displaying an operation state of the air conditioner, for example, a set temperature set for the air conditioner may be displayed.

When the controller 30 of the present embodiment detects activation of the excavator 100 (step S301), the controller 30 causes the display device 40 to display information indicating an operation state of the air conditioner in the specific display area of the display device 40 (step S302).

Subsequently, the controller 30 determines whether or not the crane mode is selected as the operation mode of the excavator 100 (step S303).

Specifically, the controller 30 determines whether or not a predetermined switch arranged in the cab 10 is operated by an operator of the excavator 100. The controller 30 may determine whether or not to select the crane mode based on the information acquired by the object monitoring device S6 or the posture of the attachment detected by the posture detection device.

In the case where the crane mode is not selected in step S303, the controller 30 waits until the crane mode is selected.

In the case where the crane mode is selected in step S303, the controller 30 erases the information indicating an operation state of the air conditioner displayed in the specific display area and displays information regarding an inclination of the machine body of the excavator 100 (step S304).

In other words, the controller 30 causes the display controller 53 to display information regarding an inclination of the machine body in the display area having displayed the information indicating an operation state of the air conditioner. Here, the information indicating an operation state of the air conditioner is information displayed in the specific display area of the display device 40 before the operation mode of the excavator 100 is switched to the crane mode.

Subsequently, the controller 30 determines whether or not the air conditioner is operated (step S305). Specifically, the controller 30 determines whether or not the air conditioner is operated by an operator via the input device 42.

In the case where it is determined in step S305 that the air conditioner is not operated, the controller 30 waits until the air conditioner is operated.

In the case where it is determined in step S305 that the air conditioner is operated, the controller 30 switches the display in the specific display area from the information regarding an inclination of the machine body to the information indicating an operation state of the air conditioner (step S306).

In other words, the controller 30 causes the display controller 53 to erase the information regarding an inclination of the machine body from the specific display area and display the information indicating an operation state of the air conditioner instead.

Subsequently, the controller 30 determines whether or not an operation of moving the machine body of the excavator 100 has been performed (step S307).

In the case where it is determined in step S307 that an operation of moving the machine body has been performed, the controller 30 proceeds to step S309, which is described later.

In the case where it is determined in step S307 that an operation of moving the machine body has not been performed, the controller 30 determines whether or not a predetermined length of time has elapsed (step S308). In the case where it is determined in step S308 that a predetermined length of time has not elapsed, the controller 30 waits until the predetermined time elapses.

In the case where it is determined in step S308 that a predetermined length of time has elapsed, the controller 30 switches the display of the specific display area from the information indicating an operation state of the air conditioner to the information regarding an inclination of the machine body (step S309). In other words, the controller 30 causes the information regarding an inclination of the machine body to be displayed again in the specific display area.

Subsequently, when the controller 30 detects that the operation of the excavator 100 has stopped (step S310), the controller 30 ends the process.

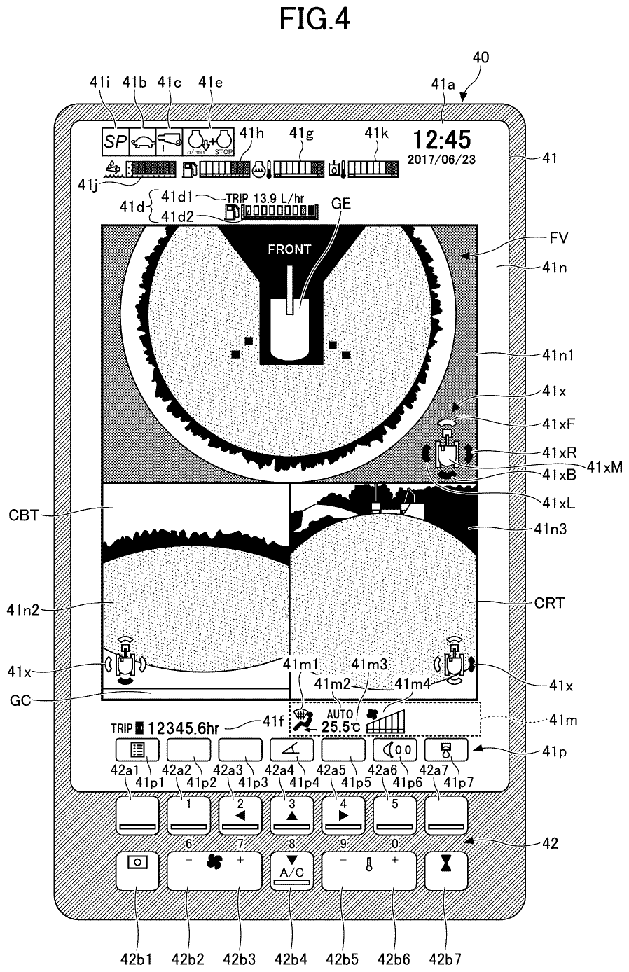

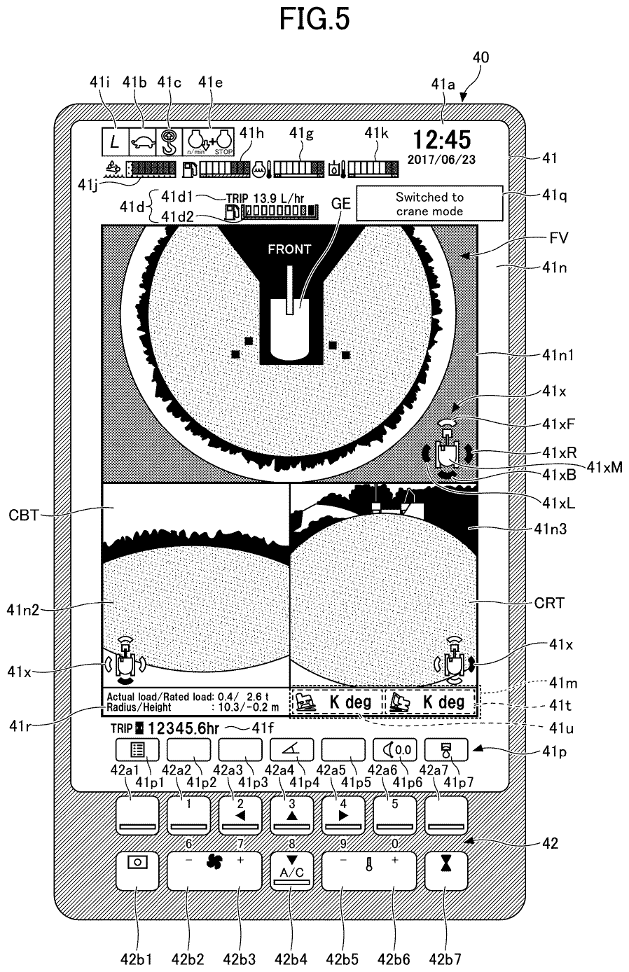

Hereinafter, a display example of the display device 40 of the present embodiment will be described with reference to FIGS. 4 and 5. FIG. 4 is a first diagram illustrating a display example of the display device 40.

The display example illustrated in FIG. 4 is an example of a screen displayed on the display device 40 in step S302 of FIG. 3, for example. In other words, the display example illustrated in FIG. 4 is an example of a screen displayed on the display device 40 in the case where the operation mode of the excavator 100 is the excavator mode.

First, the image display part 41 will be described. As illustrated in FIG. 4, the image display part 41 includes a date and time display area 41a, a travel mode display area 41b, an attachment display area 41c, a fuel consumption display area 41d, an engine control state display area 41e, an engine operating time display area 41f, a coolant temperature display area 41g, a remaining fuel amount display area 41h, a rotation speed mode display area 41i, a remaining urea-water amount display area 41j, a hydraulic oil temperature display area 41k, an air conditioner operation state display area 41m, an image display area 41n, and a menu display area 41p.

The travel mode display area 41b, the attachment display area 41c, the engine control state display area 41e, the rotation speed mode display area 41i, and the air conditioner operation state display area 41m are areas for displaying setting state information which is information regarding a setting state of the excavator 100. The fuel consumption display area 41d, the engine operating time display area 41f, the coolant temperature display area 41g, the remaining fuel amount display area 41h, the remaining urea-water amount display area 41j, and the hydraulic oil temperature display area 41k are areas for displaying operation state information that is

Information regarding an operation state of the excavator 100.

Specifically, the date and time display area 41a is an area for displaying a current date and time. The travel mode display area 41b is an area for displaying a current travel mode. The attachment display area 41c is an area for displaying an image representing the end attachment currently mounted.

The fuel consumption display area 41d is an area for displaying fuel consumption information calculated by the controller 30. The fuel consumption display area 41d includes a mean fuel consumption display area 41d1 for displaying a lifetime mean fuel consumption or a section mean fuel consumption, and an instantaneous fuel consumption display area 41d2 for displaying an instantaneous fuel consumption.

The engine control state display area 41e is an area for displaying a control state of the engine 11. The engine operating time display area 41f is an area for displaying a cumulative operating time of the engine 11. The coolant temperature display area 41g is an area for displaying a current temperature state of the engine coolant. The remaining fuel amount display area 41h is an area for displaying a state of remaining fuel amount stored in the fuel tank. The rotation speed mode display area 41i is an area for displaying a current rotation speed mode set by an engine rotation speed adjustment dial as an image. In FIG. 4, an icon image indicating “SP mode” is displayed in the rotation speed mode display area 41i. The SP mode is a rotation speed mode selected in the case where a work amount is to be prioritized, and is a rotation speed mode in which an engine rotation speed is the highest.

The remaining urea-water amount display area 41j is an area for displaying a remaining amount of urea-water stored in the urea-water tank as an image. The hydraulic oil temperature display area 41k is an area for displaying a temperature state of a hydraulic oil in the hydraulic oil tank.

The air conditioner operation state display area 41m is a display area in which information indicating an operation state of the air conditioner is displayed. The air conditioner operation state display area 41m is a specific display area in which information indicating an inclination of the machine body (information regarding a digital level) is displayed instead of information indicating an operation state of the air conditioner in the case where the crane mode is selected as an operation mode of the excavator 100.

The air conditioner operation state display area 41m includes an air outlet display area 41m1 for displaying a current position of the air outlet, an operation mode display area 41m2 for displaying a current operation mode, a temperature display area 41m3 for displaying a current setting temperature, and an air volume display area 41m4 for displaying a current setting air volume.

The image display area 41n is an area for displaying an image captured by the object monitoring device S6 as an imaging device. In the example of FIG. 4, the image display area 41n displays a bird's-eye view image FV, a rear-view image CBT, and a right-view image CRT. The bird's-eye view image FV is a virtual viewpoint image generated by a controller of the display device 40, and is generated based on images acquired by the rear camera S6B, the left camera S6L, and the right camera S6R. An excavator figure GE corresponding to the excavator 100 is arranged in a central portion of the bird's-eye view image FV. This is for allowing an operator to intuitively ascertain the positional relationship between the excavator 100 and an object existing around the excavator 100.

The rear-view image CBT is an image showing a space behind the excavator 100 and includes an image GC of a counterweight. The rear-view image CBT is a real viewpoint image generated by the controller of the display device 40, and is generated based on an image acquired by the rear camera S6B. The right-view image CRT is an image showing a space on the right side of the excavator 100, and is generated based on an image acquired by the right camera S6R.

The image display area 41n includes a first image display area 41n1 located at the upper side, and a second image display area 41n2 and a third image display area 41n3 located at the lower side. In the example of FIG. 4, the bird's-eye view image FV is arranged in the first image display area 41n1, the rear-view image CBT is arranged in the second image display area 41n2, and the right-view image CRT is arranged in the third image display area 41n3. The image display area 41n may be, however, configured such that the bird's-eye view image FV is arranged in the second image display area 41n2 and the rear-view image CBT is arranged in the first image display area 41n1.

In the example of FIG. 4, the bird's-eye view image FV, the rear-view image CBT, and the right-view image CRT are arranged adjacent to each other in the vertical direction, but may be arranged with a space therebetween. In the example of FIG. 4, the image display area 41n is a vertically long area, but the image display area 41n may be a horizontally long area. In the case where the image display area 41n is a horizontally long area, the image display area 41n may be configured such that the bird's-eye view image FV is arranged as the first image display area 41n1 on the left side, and the rear-view image CBT and the right-view image CRT are arranged as the second image display area 41n2 and the second image display area 41n2 on the right side. In this case, the images may be arranged with a space left and right, or the positions of the bird's-eye view image FV and the rear-view image CBT may be switched.

Furthermore, in the present embodiment, an icon image 41x is displayed in each of the first image display area 41n1, the second image display area 41n2, and the third image display area 41n3. The icon image 41x is an image representing a relative relationship between the position of the object monitoring device S6 as the imaging device and the orientation of the attachment of the upper slewing body 3.

The icon image 41x of the present embodiment includes an image 41xM of the excavator 100, an image 41xF showing the front of the excavator 100, and an image 41xB showing the rear of the excavator 100. The icon image 41x includes an image 41xL showing the left side of the excavator 100 and an image 41xR showing the right side of the excavator 100.

The images 41xF, 41xB, 41xL, and 41xR correspond to the front camera S6F that captures an image of the front of the excavator 100, the rear camera S6B that captures an image of the rear of the excavator 100, the left camera S6L that captures an image of the left side of the excavator 100, and the right camera S6R that captures an image of the right side of the excavator 100, respectively.

In the present embodiment, when an image associated with a corresponding camera is selected in the icon image 41x, an image captured by the camera corresponding to the selected image is displayed in the image display area 41n.

In the example of FIG. 4, in the first image display area 41n1, the display mode of the images 41xB, 41xL, and 41xR is different from the display mode of the image 41xF. Therefore, it is understood that the first image display area 41n1 displays the bird's-eye view image obtained by combining the images captured by the rear camera S6B, the left camera S6L, and the right camera S6R corresponding to the images 41xB, 41xL, and 41xR, respectively.

In the second image display area 41n2, the display mode of the image 41xB is different from the display mode of the images 41xF, 41xL, and 41xR. For this reason, it is understood that the image captured by the rear camera S6B corresponding to the image 41xB is displayed in the second image display area 41n2. In the third image display area 41n3, the display mode of the image 41xR is different from the display mode of the images 41xF, 41xL, and 41xB. For this reason, it is understood that the image captured by the right camera S6R corresponding to the image 41xR is displayed in the third image display area 41n3.

The menu display area 41p includes tabs 41p1 through 41p7. In the example of FIG. 4, the tabs 41p1 through 41p7 are arranged at the lowermost portion of the image display part 41 so as to be spaced apart from each other in the left-right direction. Icons for displaying various kinds of information are displayed in the tabs 41p1 through 41p7.

The tab 41p1 displays a menu detail item icon for displaying a menu detail item. When an operator selects the tab 41p1, the icons displayed in the tabs 41p2 through 41p7 are switched to icons associated with the detailed menu items.

An icon for displaying information regarding the digital level is displayed on the tab 41p4. When the tab 41p4 is selected by an operator, the rear-view image CBT is switched to a screen illustrating information regarding the digital level. However, a screen indicating information regarding the digital level may be displayed by being superimposed on the rear-view image CBT or by reducing the rear-view image CBT. The bird's-eye view image FV may be switched to a screen illustrating information regarding the digital level, or a screen illustrating information regarding the digital level may be displayed by being superimposed on the bird's-eye view image FV or by reducing the bird's-eye view image FV.

An icon for displaying information regarding computerized construction is displayed on the tab 41p6.

When the tab 41p6 is selected by an operator, the rear-view image CBT is switched to a screen showing information regarding computerized construction. However, the screen indicating information regarding computerized construction may be displayed by being superimposed on the rear-view image CBT or by reducing the rear-view image CBT. The bird's-eye view image FV may be switched to a screen showing information regarding computerized construction, or a screen showing information regarding computerized construction may be displayed by being superimposed on the bird's-eye view image FV or by reducing the bird's-eye view image FV.

An icon for displaying information regarding the crane mode is displayed on the tab 41p7. When the tab 41p7 is selected by an operator, the rear-view image CBT is switched to a screen showing information regarding the crane mode. However, the screen indicating information regarding the crane mode may be displayed by being superimposed on the rear-view image CBT or by reducing the rear-view image CBT. The bird's-eye view image FV may be switched to a screen showing information regarding the crane mode, or a screen showing information regarding the crane mode may be displayed by being superimposed on the bird's-eye view image FV or by reducing the bird's-eye view image FV.

No icon is displayed in the tabs 41p2, 41p3, and 41p5. For this reason, even if the tabs 41p2, 41p3, or 41p5 are operated by an operator, the image displayed on the image display part 41 does not change.

The icons displayed in the tabs 41p1 through 41p7 are not limited to the above-described examples, and icons for displaying other information may be displayed.

Next, the input device 42 will be described. As illustrated in FIG. 4, the input device 42 is a switch panel, and is configured by one or a plurality of button-type switches with which an operator selects the tabs 41p1 through 41p7, inputs settings, and the like. In the example of FIG. 4, the input device 42 includes seven switches 42a1 through 42a7 arranged in an upper stage and seven switches 42b1 through 42b7 arranged in a lower stage. The switches 42b1 through 42b7 are arranged below the switches 42a1 through 42a7, respectively. However, the number, form, and arrangement of the switches of the input device 42 are not limited to the above-described example. For example, the functions of a plurality of button-type switches are integrated into a jog wheel, a jog switch, or the like, or the input device 42 may be provided separately from the display device 40. Alternatively, the tabs 41p1 through 41p7 may be directly operated on a touch panel in which the image display part 41 and the input device 42 are integrated.

The switches 42a1 through 42a7 are arranged below the tabs 41p1 through 41p7 so as to correspond to the tabs 41p1 through 41p7, respectively, and function as switches for selecting the tabs 41p1 through 41p7, respectively. Since the switches 42a1 through 42a7 are arranged below the tabs 41p1 through 41p7, respectively, in correspondence with the tabs 41p1 through 41p7, an operator can intuitively select the tabs 41p1 through 41p7.

The switch 42b1 is a switch for switching a captured image displayed in the image display area 41n. The input device 42 is configured in such a manner that the captured image displayed in the first image display area 42n1 of the image display area 41n is switched among, for example, a rear-view image, a left-view image, a right-view image, and an overhead image every time the switch 42b1 is operated. The input device 42 may be configured in such a manner that the captured image displayed in the second image display area 41n2 of the image display area 41n is switched among, for example, a rear-view image, a left-view image, a right-view image, and an overhead image every time the switch 42b1 is operated.

The input device 42 may be configured in such a manner that the captured image displayed in the first image display area 41n1 of the image display area 41n, the captured image displayed in the second image display area 41n2, and the captured image displayed in the third image display area 41n3 are interchanged with each other every time the switch 42b1 is operated.

As described above, the switch 42b1 as the input device 42 may switch the screen displayed in each of the first image display area 41n1, the second image display area 41n2, and the third image display area 41n3. A switch for switching the screen displayed in the second image display area 41n2 and a switch for switching the third image display area 41n3 may be separately provided.

The switches 42b2 and 42b3 are switches for adjusting an air volume of the air conditioner. In the example of FIG. 4, the air volume of the air conditioner is reduced when the switch 42b2 is operated, and the air volume of the air conditioner is increased when the switch 42b3 is operated.

The switch 42b4 is a switch for switching on/off of a cooling/heating function. In the example of FIG. 4, the cooling/heating function is switched on and off each time the switch 42b4 is operated.

The switches 42b5 and 42b6 are switches for adjusting a preset temperature of the air conditioner. In the example of FIG. 4, the preset temperature is lowered when the switch 42b5 is operated, and the preset temperature is raised when the switch 42b6 is operated.

In other words, the switches 42b2, 42b3, 42b4, 42b5, and 42b6 are input devices on which an operation of changing content of information displayed in the specific display area is performed. When the operation mode of the excavator 100 is the crane mode, if any of these switches is operated, the controller 30 causes the air conditioner operation state display area 41m to display information indicating an operation state of the air conditioner.

The switch 42b7 is a switch that can switch the display of an engine operating time display area 41f.

The switches 42a2 through 42a6 and 42b2 through 42b6 are configured to allow input of numbers displayed on the respective switches or near the switches. The switches 42a3, 42a4, 42a5, and 42b4 are configured to move a cursor to the left, up, right, and down, respectively, when the cursor is displayed on the menu screen.

The functions given to the switches 42a1 through 42a7 and 42b1 through 42b7 are merely examples, and the switches may be configured to be able to execute other functions.

The bird's-eye view image FV is displayed in the image display area 41n without changing the size before versus after the tab 41p1 is selected. Visibility when an operator checks the periphery of the excavator 100 is not deteriorated.

FIG. 5 is a second diagram illustrating a display example of the display device 40. The screen illustrated in FIG. 5 is an example of a screen displayed on the display device 40 when the operation mode of the excavator 100 is set to the crane mode. In other words, the screen illustrated in FIG. 5 is an example of the screen displayed on the display device 40 in step S304 of FIG. 3, for example.

In FIG. 5, an icon image indicating that a currently attached end attachment is an end attachment with a hook to which a hook is attached is displayed in the attachment display area 41c, and it can be understood that the operation mode of the excavator 100 is the crane mode.

In FIG. 5, an icon image indicating “L mode” is displayed in the rotation speed mode display area 41i. The L mode is a rotation speed mode that makes the acceleration characteristic and the deceleration characteristic of the hydraulic actuator corresponding to the lever operation gentle and is selected when it is desired to improve accurate operability and safety and operate the excavator 100 with low noise, and is a mode in which the rotation speed is lower than that in the SP mode.

The image display part 41 illustrated in FIG. 5 includes a message display area 41q and a crane information display area 41r.

In the message display area 41q, a message indicating that the crane mode is selected as the operation mode of the excavator 100 is displayed. The message display area 41q may be erased from the image display part 41 when the operation of the excavator 100 is switched from the crane mode to the excavator mode. When the operation of the excavator 100 is switched from the crane mode to the excavator mode, the message display area 41q may be erased after displaying the message indicating that the excavator mode is selected for a certain period of time.

Crane information is displayed in the crane information display area 41r. The crane information includes information indicating a rated load in the crane mode and information indicating an actual load of a suspended load LD. The crane information includes information indicating a work radius in the crane mode and information indicating a height of a target hanging position of the suspended load LD.

The working radius is a horizontal distance from the slew center of the excavator 100 to the center of the hook 20. The target hanging position of a suspended load LD is a position set directly above a center of gravity of the suspended load LD, and the height of the hanging position is determined based on the length of the wire WR. In this case, the length of the wire WR may be input in advance via the input device 42. The height of the hanging position may be a vertical distance from the ground to the center of the hook 20.

In FIG. 5, information indicating an inclination of the machine body of the excavator 100 is displayed in the air conditioner operation state display area 41m instead of information indicating an operation state of the air conditioner.

In other words, the air conditioner operation state display area 41m is a display area including the display areas 41t and 41u instead of the air outlet display area 41m1, the operation mode display area 41m2 for displaying a current operation mode, the temperature display area 41m3 for displaying a current setting temperature, and the air volume display area 41m4 for displaying a current setting air volume.

In the display areas 41t and 41u, information regarding an inclination of the machine body of the excavator 100 is displayed. The display area 41t displays information indicating an inclination of the machine body of the excavator 100 about the longitudinal axis of the machine body. In other words, the display area 41t displays information regarding a pitch angle of the machine body of the excavator 100.

The display area 41u displays information indicating an inclination of the machine body of the excavator 100 about the lateral axis of the machine body. In other words, the display area 41u displays information regarding a roll angle of the machine body of the excavator 100.

In the example of FIG. 5, in the display area 41u, an icon image indicating an inclination state of the machine body of the excavator 100 about the longitudinal axis and a roll angle of the excavator 100 are displayed in association with each other. In the example of FIG. 5, in the display area 41t, an icon image indicating a state in which the machine body of the excavator 100 is inclined around the lateral axis and a pitch angle of the excavator 100 are displayed in association with each other.

In the present embodiment, by displaying an icon image indicating an inclination state of the machine body together with an inclination angle of the machine body of the excavator 100 in this way, an operator can ascertain a specific inclination angle of the machine body while envisaging the state of the machine body of the excavator 100.

In the present embodiment, the crane information display area 41m is displayed together with the air conditioner operation state display area 41r in which information indicating an inclination of the machine body of the excavator 100 is displayed. Therefore, according to the present embodiment, an operator can ascertain a rated load and an actual load in the crane mode together with an inclination of the machine body of the excavator 100. In the example of FIG. 5, the crane information display area 41m is displayed adjacent to the air conditioner operation state display area 41r. Therefore, in the present embodiment, when visually recognizing an inclination of the machine body of the excavator 100, an operator can ascertain a rated load and an actual load in the crane mode without changing the direction of the line of sight.

In the present embodiment, an icon image indicating an inclination state of the machine body and an inclination angle are displayed in each of the display areas 41t and 41u, but the present invention is not limited thereto. For example, only an icon image indicating an inclination state of the machine body of the excavator 100 around the longitudinal axis may be displayed in the display area 41u, and for example, only an icon image indicating an inclination state of the machine body of the excavator 100 around the lateral axis may be displayed in the display area 41t.

In the present embodiment, as described above, an inclination state of the machine body of the excavator 100 is indicated only by an icon image, and it is thus possible to reduce the space of the display area for displaying information regarding an inclination of the machine body of the excavator 100, and to effectively use the display area of the image display part 41.

In the present embodiment, the air conditioner operation state display area 41m is set as a specific display area, and when the crane mode is selected as an operation mode of the excavator 100, information regarding an inclination of the machine body of the excavator 100 is displayed in the air conditioner operation state display area 41m. However, the present invention is not limited thereto.

In the present embodiment, a display area other than the air conditioner operation state display area 41m may be set as a specific display area, and information regarding an inclination of the machine body of the excavator 100 may be displayed in the specific display area other than the air conditioner operation state display area 41m.

Specifically, the date and time display area 41a, for example, may be set as a specific display area. In this case, when the crane mode is selected as an operation mode of the excavator 100, the controller 30 may erase information regarding a date and time displayed in the date and time display area 41a and display information regarding an inclination of the machine body of the excavator 100.

In the present embodiment, for example, when the crane mode is selected as an operation mode of the excavator 100, any one of the bird's-eye view image FV, the rear-view image CBT, and the right-view image CRT may be reduced, and information regarding an inclination of the machine body of the excavator 100 may be displayed in a space generated by the reduction. In the present embodiment, for example, when the crane mode is selected as an operation mode of the excavator 100, information regarding an inclination of the machine body of the excavator 100 may be displayed in any one of the bird's-eye view image FV, the rear-view image CBT, and the right-view image CRT.

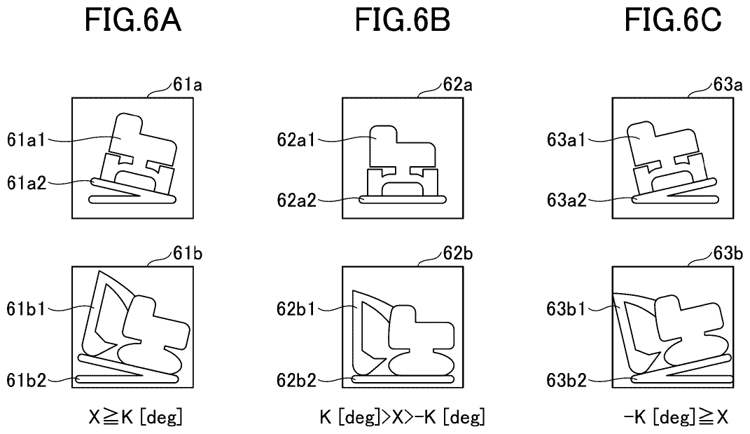

Next, an icon image indicating an inclination state of the machine body in the present embodiment will be described with reference to FIGS. 6A through 6C. FIGS. 6A through 6C are diagrams for explaining icon images showing an inclination state of the machine body.

Hereinafter, the icon images indicating an inclination state of the machine body of the excavator 100 around the longitudinal axis in FIGS. 6A through 6C are described as icon images corresponding to a roll angle of the excavator 100, and the icon images indicating an inclination state of the machine body of the excavator 100 around the lateral axis in FIGS. 6A through 6C are described as icon images corresponding to a pitch angle of the excavator 100.

In the present embodiment, the icon image displayed on the display device 40 varies depending on a roll angle and a pitch angle of the excavator 100.

The icon image 61a illustrated in FIG. 6A is an icon image displayed in the display area 41u when the machine body of the excavator 100 is inclined to the right in a case where a roll angle is X. Specifically, the icon image 61a is an icon image displayed in the display area 41u when the roll angle X is equal to or larger than K[deg]. K[deg] may be a preset threshold value. The icon image 61b illustrated in FIG. 6A is an icon image displayed in the display area 41t when the machine body of the excavator 100 is inclined to the rear in a case where a pitch angle is X. Specifically, the icon image 61b is an icon image displayed in the display area 41t when the pitch angle X is equal to or larger than K[deg].

The icon image 61a includes an image 61a1 and an image 61a2, and the icon image 61b includes an image 61b1 and an image 61b2.

The image 61a1 is an image indicating an inclination of the machine body of the excavator 100 corresponding to a roll angle, and the image 61a2 is an image indicating the roll angle. The image 61b1 is an image indicating an inclination of the machine body of the excavator 100 corresponding to a pitch angle, and the image 61b2 is an image indicating the pitch angle.

The icon image 62a illustrated in FIG. 6B is an icon image displayed in the display area 41u when the machine body of the excavator 100 is laterally parallel in a case where a roll angle is X. Specifically, the icon image 62a is an icon image displayed in the display area 41u when a roll angle X is smaller than K[deg] and larger than −K[deg]. The icon image 62b illustrated in FIG. 6B is an icon image displayed in the display area 41t when the machine body of the excavator 100 is longitudinally parallel in a case where a pitch angle is X. Specifically, the icon image 62b is an icon image displayed in the display area 41t when a pitch angle X is smaller than K[deg] and larger than −K[deg].

The icon image 62a includes an image 62a1 and an image 62a2, and the icon image 62b includes an image 62b1 and an image 62b2.

The image 62a1 is an image indicating an inclination of the machine body of the excavator 100 corresponding to a roll angle, and the image 62a2 is an image indicating the roll angle. The image 62b1 is an image indicating an inclination of the machine body of the excavator 100 corresponding to a pitch angle, and the image 62b2 is an image indicating the pitch angle.

The icon image 63a illustrated in FIG. 6C is an icon image displayed in the display area 41u when the machine body of the excavator 100 is inclined to the left in a case where a roll angle is X. Specifically, the icon image 63a is an icon image displayed in the display area 41u when a roll angle X is equal to or smaller than −K[deg]. The icon image 63b illustrated in FIG. 6C is an icon image displayed in the display area 41t when the machine body of the excavator 100 is inclined to the front in a case where a pitch angle is X. Specifically, the icon image 63b is an icon image displayed in the display area 41t when a pitch angle X is equal to or smaller than −K[deg].

The icon image 63a includes an image 63a1 and an image 63a2, and the icon image 63b includes an image 63b1 and an image 63b2.

The image 63a1 is an image indicating an inclination of the machine body of the excavator 100 corresponding to a roll angle, and the image 63a2 is an image indicating the roll angle. The image 63b1 is an image indicating an inclination of the machine body of the excavator 100 corresponding to a pitch angle, and the image 63b2 is an image indicating the pitch angle.

In the examples of FIGS. 6A through 6C, when the icon image corresponding to a roll angle and a pitch angle is selected, the common threshold value K set for a roll angle and a pitch angle is used, but the present invention is not limited thereto. The thresholds K may be set to different values for a roll angle and a pitch angle, and the icon images displayed in the display areas 41u and 41t may be selected based on the respective thresholds K.

As described above, in the present embodiment, the shape of the icon image to be displayed varies depending on a roll angle and a pitch angle of the machine body of the excavator 100. Therefore, according to the present embodiment, an operator can ascertain an inclination of the machine body of the excavator 100 only through displaying the icon images having shapes corresponding to a roll angle and a pitch angle without displaying numerical values indicating a roll angle and a pitch angle.

The shapes of the icon images displayed according to a roll angle and a pitch angle are not limited to the shapes illustrated in FIGS. 5 and 6A through 6C. The shapes of the icon images displayed according to a roll angle and a pitch angle may be any shape as long as the icon image shows that the machine body of the excavator 100 is inclined. Specifically, for example, the shapes of the icon images displayed according to a roll angle and a pitch angle may be a shape imitating a bubble-type level.

The preferred embodiments of the present disclosure have been described in detail above. However, the present disclosure is not limited to the above-described embodiments. Various modifications, substitutions, and the like can be applied to the above-described embodiment without departing from the scope of the present disclosure. Also, features described separately can be combined as long as no technical contradiction arises.

For example, in the above-described embodiment, a pilot pressure type control valve is employed, but an electromagnetic type control valve may be employed. In this case, the operation device 26 may be an electric operation lever.

What is claimed is:

1. An excavator, comprising:
a lower travel body;
an upper slewing body mounted on the lower travel body in a slewable manner;
a sensor configured to detect an inclination of a machine body with respect to a horizontal plane;
a display device installed inside a cabin provided in the upper slewing body; and
a control device configured to cause the display device to display an icon image resembling a shape of the machine body as information regarding the inclination of the machine body when an operation mode is switched to a crane mode.

2. The excavator according to claim 1, wherein
the control device causes the display device to display information indicating a rated load in the crane mode and information indicating an actual load, together with the information regarding the inclination of the machine body.

3. The excavator according to claim 2, wherein
the control device sets the information regarding the inclination of the machine body displayed on the display device to non-display when the operation mode is switched from the crane mode to another mode.

4. The excavator according to claim 1, wherein
the information regarding the inclination of the machine body includes the icon image resembling the shape of the machine body and a numerical value indicating the inclination of the machine body.

5. The excavator according to claim 1, wherein
when the operation mode is switched to the crane mode, the control device switches information displayed in a specific display area of the display device from information displayed before the operation mode is switched to the crane mode to the information regarding the inclination of the machine body.

6. The excavator according to claim 5, wherein
when an operation of changing content of information displayed in the specific display area before the operation mode is switched to the crane mode is received during an operation in the crane mode, the control device switches the display in the specific display area from the information regarding the inclination of the machine body to the information displayed before the operation mode is switched to the crane mode.

7. The excavator according to claim 6, wherein
when an operation of moving the machine body of the excavator is received after the operation of changing content of the information is received, the control device causes the specific display area to display the information regarding the inclination of the machine body again.

8. The excavator according to claim 7, wherein
in a case where the operation of moving the machine body of the excavator is not performed even after a predetermined length of time has elapsed after the operation of changing content of the information is received, the control device causes the specific display area to display the information regarding the inclination of the machine body again.

9. The excavator according to claim 5, wherein
the specific display area is an area in which information that does not change due to the operation of moving the machine body of the excavator is displayed.

10. The excavator according to claim 1, wherein
the sensor is an inertial measurement unit, and
the control device causes the icon image resembling the shape of the machine body to be displayed with an inclination based on a value that is output from the sensor.

11. The excavator according to claim 1, wherein
the control device causes the icon image resembling the shape of the machine body and an image indicating a roll angle of the machine body or a pitch angle of the machine body to be displayed in association with each other, as the information regarding the inclination of the machine body.
